(19) United States
(12) Patent Application Publication
(10) Pub. No.: US 2009/0014040 A1
(43) Pub. Date: Jan. 15, 2009

(54) FLEXIBLE OBJECT CLEANING AID

(76) Inventor: Danny Leblond, Sherbrooke (CA)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(21) Appl. No.: 11/775,884

(22) Filed: Jul. 11, 2007

(51) Int. Cl. B08B 13/00

(52) U.S. Cl. 134/157

(57) ABSTRACT

A rotative cleaning system includes a flexible member mounted in a stationary location and having an object engagement edge that contacts an exterior surface or region of an object as is rotates within the cleaning system, to dislodge dirt, paint, fluid or other substance from the object.

### TECHNICAL FIELD

The present invention relates to the cleaning of generally round objects and more particularly, to a flexible device which intermittently contacts an object to be cleaned to dislodge dirt and the like from the object and to remove water or other liquid contained in the object to aid the object to dry.

### BACKGROUND INFORMATION

Rotative cleaning devices are well known. For example, the present inventor has developed a rotative cleaning system covered by U.S. Pat. No. 6,578,590. Such devices work well for applying a high pressure generally uniform fan of cleaning solution against an object to be cleaned, such as a cartridge filter element, painting devices such as a paint roller covers or the like. Unfortunately, objects such as paint roller covers are very dense and it takes significant time, cleaning fluid and pressure to dislodge all of the dirt or other contaminant in the device. In addition, once the cleaning solution has been stopped, it takes a considerable amount of time to expel or dry all of the cleaning fluid now located in the device being cleaned.

Accordingly, a need exists for a device which can be utilized in conjunction with one of the prior art rotative cleaning devices and which serves to assist such cleaning devices in dislodging dirt from the objects to be cleaned and in expelling any cleaning fluid remaining in the objects being cleaned.

### SUMMARY

The present invention is directed to a rotative cleaning system having a flexible cleaning aid. The system includes a holding mechanism configured for holding at least one object to be cleaned and a rotation mechanism, configured for rotating the object to be cleaned. The system further includes a flexible cleaning aid having a support edge and an object engagement edge, the flexible cleaning aid is non-rotatably mounted in said rotative cleaning system in a generally fixed position proximate its support edge, and configured or arranged such that the object engagement edge of the flexible cleaning aid contacts an exterior surface of the at least one object to be cleaned as the object to be cleaned is rotated by the rotation mechanism and into contact with the object engagement edge of the flexible cleaning aid.

The object to be cleaned may include objects such as a pool filter, a spa filter and a paint roller cover. In one embodiment, the rotative cleaning system is configured to hold one object to be cleaned while in another embodiment, two or more objects to be cleaned may be supported.

### BRIEF DESCRIPTION OF THE DRAWINGS

These and other features and advantages of the present invention will be better understood by reading the following detailed description, taken together with the drawings wherein:

FIG. 1 is a side perspective view of the flexible cleaning aid in accordance with the present invention;

FIG. 2 is top view of the flexible cleaning aid used in connection with one object to be cleaned in accordance with the present invention;

FIG. 3 is a top perspective view of the flexible cleaning aid used in connection with multiple objects to be cleaned in accordance with the present invention; and

FIG. 4 is a side perspective view of the flexible cleaning aid used in connection with multiple objects to be cleaned in accordance with the teachings of the present invention.

### DETAILED DESCRIPTION OF THE PREFERRED EMBODIMENTS

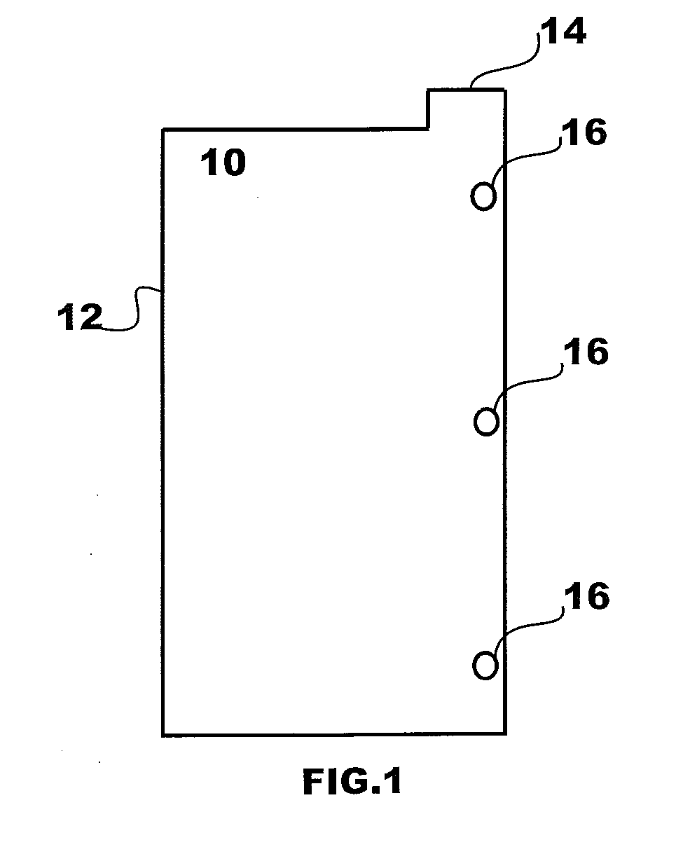

The present invention features a flexible cleaning aid 10, FIG. 1 which is made of a flexible and resilient plastic or rubber-like material and is intended to contact an object being cleaned, as will be explained in greater detail below. The flexible cleaning aid 10 includes a first edge 12 which is intended to make contact with the object being cleaned and a second edge region 14 which is used to secure the flexible cleaning aid 10 in place so that it will appropriately contact the object being cleaned. The second end region 14 may include one or more holes or a slot 16 used to help secure the aid 10 in-place.

For exemplary purposes only, the present invention will be explained in connection with a rotative cleaning system such as that described in U.S. Pat. No. 6,578,590 which is incorporated fully herein by reference. The system disclosed in the above-referenced United States patent is not a limitation of the present invention as one of ordinary skill in the art will appreciate that the flexible cleaning aid 10 according to the teachings of the present invention may be utilized with many different types of rotative cleaning systems. Further, although the present invention will be explained in connection with a “cleaning” system, this is not a limitation of the present invention as the flexible cleaning aid 10 may be utilized with other types of liquid based re-hydration, preservation or other similar system uses.

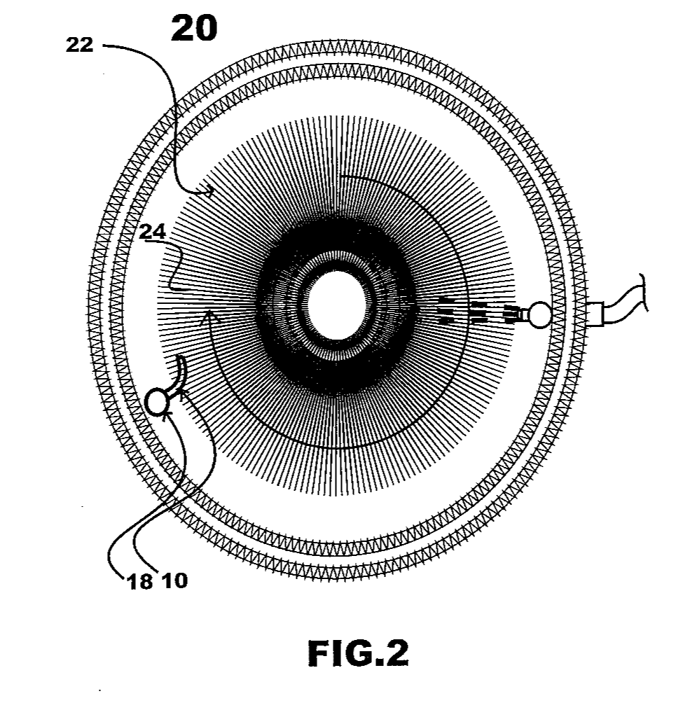

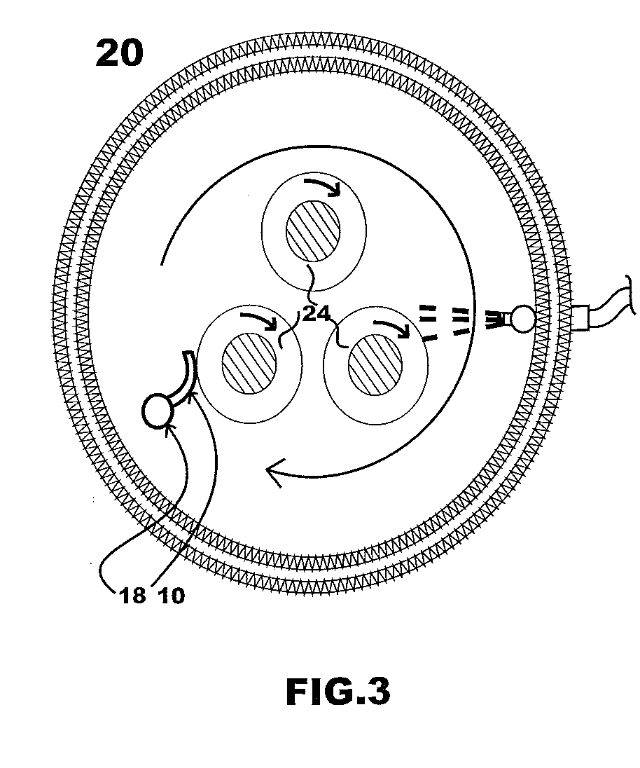

As shown in FIG. 2, the flexible cleaning aid 10 is held in place by a support 18 located within the rotative cleaning system 20. The flexible cleaning aid 10 is positioned such that it will contact the side region 22 of an object to be cleaned 24. Examples of objects to be cleaned include pool or spa filters, paint roller covers, or other similar objects which are intended to be cleaned and reused. The flexible cleaning aid 10, FIG. 3 in accordance with the present invention is shown in use with a system wherein three objects to be cleaned 24 such as paint roller covers are disposed in the rotative cleaning system 20. The flexible cleaning aid 10 serves both to dislodge any direct located in the objects to be cleaned 24 and once cleaning has stopped, to dislodge water or other fluids still found within the objects 24. In the preferred embodiment, the objects to be cleaned 24 also rotate about their own vertical or horizontal axis separate and apart from rotation of the support that the objects are mounted to. The support could be a turntable, a base, or arms extending from a shaft, for example only. In this manner, the flexible cleaning aid 10 is more apt to contact the object to be cleaned 24 along its entire exterior surface.

The flexible cleaning aid 10 is preferably mounted onto a support member 18 such as a circular pipe type device in which the flexible cleaning aid 10 has been inserted or mounted. The support member 18 is mounted or otherwise held in place within the rotative cleaning system 20 and serves to hold or support the flexible cleaning aid 10.

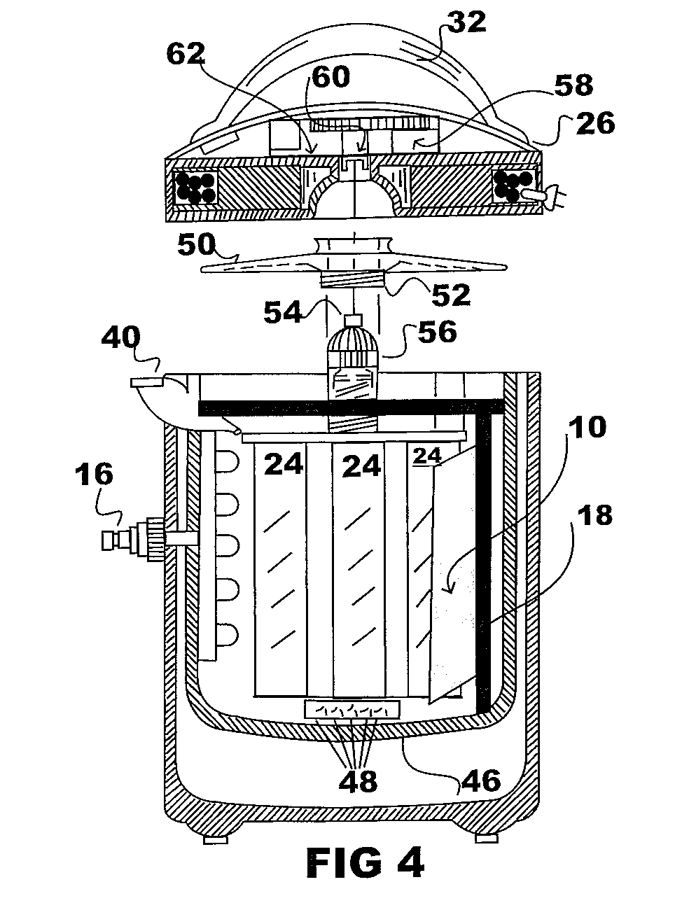

Preferably, the flexible cleaning aid 10 is approximately as long as the object to be cleaned 24 as shown in FIG. 4, to help ensure that generally the entire exterior surface of the object to be cleaned comes in contact with the flexible cleaning aid 10 to help dislodge any dirt, water or other fluid located in the object.

The present invention is not intended to be limited to a system or method which must satisfy one or more of any stated or implied objects or feature of the invention and should not be limited to the preferred, exemplary, or primary embodiment(s) described herein. Modifications and substitutions by one of ordinary skill in the art are considered to be within the scope of the present invention, which is not to be limited except by the allowed claims in their legal equivalents.

The invention claimed is:

1. A rotative cleaning system having a flexible cleaning aid, said system comprising:
a holding mechanism configured for holding at least one object to be cleaned;
a rotation mechanism configured for rotating said object to be cleaned; and
a flexible cleaning aid having a support edge and an object engagement edge, said flexible cleaning aid non-rotatably mounted in said rotative cleaning system proximate said support edge, and configured such that said object engagement edge of said flexible cleaning aid contacts an exterior surface of said at least one object to be cleaned as said at least one object to be cleaned is rotated by said rotation mechanism.

2. The rotative cleaning system of claim 1, wherein said at least one object to be cleaned is selected from the group consisting of a pool filter, a spa filter and a paint roller cover.

3. The rotative cleaning system of claim 1, wherein said rotative cleaning system is configured to hold two or more objects to be cleaned.

4. A rotative fluid containing system having a flexible member, said system comprising:
a holding mechanism, configured for holding at least one object to be exposed to a fluid;
a rotation mechanism, configured for rotating said object; and
a flexible member having a support edge and an object engagement edge, said flexible member non-rotatably mounted in said rotative system proximate said support edge, and configured such that said object engagement edge of said flexible member contacts an exterior surface of said at least one object as said at least one object is rotated past said flexible member by said rotation mechanism.
